(19) United States
(12) Patent Application Publication
(10) Pub. No.: US 2024/0398029 A1
(43) Pub. Date: Dec. 5, 2024

(54) VAPORIZER CARTRIDGE TYPE DETECTION

(71) Applicant: Pax Labs, Inc., San Francisco, CA (US)

(72) Inventors: Baochun Yuan, Clovis, CA (US); Katherine Murphy, San Francisco, CA (US); Thomas Purvis Mizell, San Francisco, CA (US); Christopher Loental, San Francisco, CA (US); Ijaaz Omer, San Francisco, CA (US)

(21) Appl. No.: 18/696,910

(22) PCT Filed: Sep. 27, 2022
(86) PCT No.: PCT/US2022/044920

§ 371 Date: Mar. 28, 2024

Related U.S. Application Data
(60) Provisional application No. 63/249,447, filed on Sep. 28, 2021.

(51) Int. Cl. A24F 40/53; A24F 40/42; A24F 40/57; A24F 40/65; G05D 23/19

(52) U.S. Cl. CPC A24F 40/53; A24F 40/42; A24F 40/57; A24F 40/65; G05D 23/1904

(57) ABSTRACT

Features relating to detecting a type of vaporizer cartridge are provided. The method may include applying a proportional-integral-derivative (PID) control to regulate the heater to achieve a setpoint temperature. The method may also include generating, during the applying, an operational heating profile of the vaporizer cartridge. The method may further include detecting, based on the generated operational heating profile, a cartridge type of the vaporizer cartridge.

### CROSS-REFERENCE TO RELATED APPLICATIONS

The present application claims priority to U.S. Provisional Application No. 63/249,447, filed Sep. 28, 2021, and entitled, “Vaporizer Cartridge Type Detection,” the entirety of which is incorporated by reference herein.

### TECHNICAL FIELD

The current subject matter described herein relates generally to vaporizer devices, such as portable, personal vaporizer devices for generating and delivering an inhalable aerosol from one or more vaporizable materials, and more particularly relates to detecting a cartridge type of a vaporizer cartridge.

### BACKGROUND

Vaporizing devices, including electronic vaporizers or e-vaporizer devices, allow the delivery of vapor and aerosol containing one or more active ingredients by inhalation of the vapor and aerosol. Electronic vaporizer devices are gaining increasing popularity both for prescriptive medical use, in delivering medicaments, and for consumption of nicotine, tobacco, other liquid-based substances, and other plant-based smokeable materials, such as cannabis, including solid (e.g., loose-leaf or flower) materials, solid/liquid (e.g., suspensions, liquid-coated) materials, wax extracts, and prefilled pods (cartridges, wrapped containers, etc.) of such materials. Electronic vaporizer devices in particular may be portable, self-contained, and convenient for use.

### SUMMARY

Aspects of the current subject matter relate to detecting a cartridge type of a vaporizer cartridge, such as based on a heating profile of the vaporizer cartridge.

In some aspects, a method includes applying a proportional-integral-derivative (PID) control to regulate a heater (e.g., of a vaporizer cartridge) to achieve a setpoint temperature. The method also includes generating, during the applying, an operational heating profile of the vaporizer cartridge. The method also includes detecting, based on the generated operational heating profile, a cartridge type of the vaporizer cartridge. In some aspects, a vaporizer device includes a processor to perform the method.

In some aspects, the method includes determining, based on the detecting, whether the vaporizer cartridge is authentic, the determining including: comparing the operational heating profile to a predetermined heating profile associated with the cartridge type.

In some aspects, the method further includes authenticating the vaporizer cartridge; and permitting, based on the authenticating, use of the vaporizer cartridge.

In some aspects, the method includes: supplying current to the heater to heat a vaporizable material stored in the vaporizer cartridge to generate an aerosol.

In some aspects, the method includes: determining the vaporizer cartridge is not authentic.

In some aspects, the method includes preventing based on the determining the vaporizer cartridge is not authentic, a current from being supplied to the heater.

In some aspects, the method includes transmitting an alert indicating the vaporizer cartridge is not authentic.

In some aspects, the operational heating profile includes a heating curve defined by a plurality of temperatures of the heater. The plurality of temperatures are measured over a period of time during which the setpoint temperature is achieved.

In some aspects, the applying the PID control includes adjusting at least one of a proportional term, an integral term, and a derivative term of the PID control to achieve the setpoint temperature.

In some aspects, the cartridge type is one of a plurality of cartridge types.

In some aspects, the cartridge type includes one or more of an authenticated cartridge configuration and an authenticated heater configuration.

In some aspects, a vaporizer body is coupled to the vaporizer cartridge and a plurality of cartridge types and a plurality of a predetermined heating profiles corresponding to a respective one of the plurality of cartridge types is stored on one or more of the vaporizer body and the vaporizer cartridge.

In some aspects, the detecting includes: comparing the operational heating profile to a predetermined heating profile associated with the cartridge type.

In some aspects, the detecting further includes: determining, based on the comparing, the cartridge type of the vaporizer cartridge when the operational heating profile matches the predetermined heating profile associated with the cartridge type.

In some aspects, the determining includes applying a statistical model to determine the operational heating profile matches the predetermined heating profile associated with the cartridge type.

In some aspects, the determining includes generating a score indicating a similarity between the operational heating profile and the predetermined heating profile associated with the cartridge type.

In some aspects, the determining further includes determining the operational heating profile matches the predetermined heating profile when the score meets a threshold score.

In some aspects, the method includes: causing display, via a user device communicatively coupled to the vaporizer device, of the cartridge type and cartridge information associated with the cartridge type.

In some aspects, the generating the operational heating profile includes: applying a pulse width modulation (PWM) duty cycle to heat the heater, measuring a first temperature of the heater, and adding the measured first temperature to the operational heating profile.

In some aspects, the generating the operational heating profile further includes: determining a current temperature setpoint and adjusting, based on the current temperature setpoint, the PWM duty cycle.

In some aspects, the adjusting includes adjusting at least one of a proportional term, an integral term, and a derivative term of the PID control.

In some aspects, the generating the operational heating profile further includes: applying the adjusted PWM duty cycle to heat the heater, measuring a second temperature of the heater, and adding the measured second temperature to the operational heating profile.

In some aspects, the generating the operational heating profile further includes: determining whether an amount of temperatures added to the operational heating profile meets a threshold amount.

In some aspects, the generating the operational heating profile further includes: storing the operational heating profile when the amount of temperatures meets the threshold amount.

In some aspects, the generating the operational heating profile further includes: applying the adjusted PWM duty cycle to heat the heater, measuring an additional temperature of the heater, and adding the measured additional temperature to the operational heating profile.

In some aspects, the generating the operational heating profile further includes: adding an additional measured temperature of the heater to the operational heating profile until the amount of temperatures meets the threshold temperature.

In some aspects, a vaporizer device includes a vaporizer cartridge having a heater, at least one processor, and at least one memory storing instructions which, when executed by the at least one processor, cause operations. The operations may include applying a proportional-integral-derivative (PID) control to regulate the heater to achieve a setpoint temperature. The operations may also include generating, during the applying, an operational heating profile of the vaporizer cartridge. The operations may include detecting, based on the generated operational heating profile, a cartridge type of the vaporizer cartridge.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A-FIG. 1F illustrate features of a vaporizer device including a vaporizer body and a cartridge consistent with implementations of the current subject matter;

FIG. 2 is a schematic block diagram illustrating features of a vaporizer device having a cartridge and a vaporizer body consistent with implementations of the current subject matter;

FIG. 3 illustrates communication between a vaporizer device, a user device, and a server consistent with implementations of the current subject matter;

FIG. 4 depicts a block diagram illustrating an example of proportional-integral-derivative (PID) control consistent with implementations of the current subject matter;

FIGS. 5A-5D depicts example heating profiles of different cartridge types consistent with implementations of the current subject matter;

FIG. 6 illustrates an example flowchart showing a method of detecting a cartridge type consistent with implementations of the current subject matter; and

FIG. 7 illustrates an example chart showing features of a method for detecting a cartridge type of a vaporizer cartridge consistent with implementations of the current subject matter.

When practical, similar reference numbers denote similar structures, features, or elements.

### DETAILED DESCRIPTION

Aspects of the current subject matter relate to cartridge type detection of a vaporizer cartridge.

Before providing additional details regarding aspects of cartridge type detection of a vaporizer cartridge, the following provides a description of some examples of vaporizer devices in which aspects of the current subject matter may be implemented. The following descriptions are meant to be exemplary, and aspects related to the responsive operation of a vaporizer device consistent with the current subject matter are not limited to the example vaporizer devices described herein.

Implementations of the current subject matter include devices relating to vaporizing of one or more materials for inhalation by a user. The term “vaporizer” may be used generically in the following description and may refer to a vaporizer device, such as an electronic vaporizer. Vaporizers consistent with the current subject matter may be referred to by various terms such as inhalable aerosol devices, aerosolizers, vaporization devices, electronic vaping devices, electronic vaporizers, vape pens, etc. Examples of vaporizers consistent with implementations of the current subject matter include electronic vaporizers, electronic cigarettes, e-cigarettes, or the like. In general, such vaporizers are often portable, hand-held devices that heat a vaporizable material to provide an inhalable dose of the material. The vaporizer may include a heater configured to heat a vaporizable material which results in the production of one or more gas-phase components of the vaporizable material. A vaporizable material may include liquid and/or oil-type plant materials, or a semi-solid like a wax, or plant material such as leaves or flowers, either raw or processed. The gas-phase components of the vaporizable material may condense after being vaporized such that an aerosol is formed in a flowing air stream that is deliverable for inhalation by a user. The vaporizers may, in some implementations of the current subject matter, be particularly adapted for use with an oil-based vaporizable material, such as cannabis-derived oils although other types of vaporizable materials may be used as well.

One or more features of the current subject matter, including one or more of a cartridge (also referred to as a vaporizer cartridge or pod) and a reusable vaporizer device body (also referred to as a vaporizer device base, a body, a vaporizer body, or a base), may be employed with a suitable vaporizable material (where suitable refers in this context to being usable with a device whose properties, settings, etc. are configured or configurable to be compatible for use with the vaporizable material). The vaporizable material may include one or more liquids, such as oils, extracts, aqueous or other solutions, etc., of one or more substances that may be desirably provided in the form of an inhalable aerosol. The cartridge may be inserted into the vaporizer body, and then the vaporizable material heated which results in the inhalable aerosol.

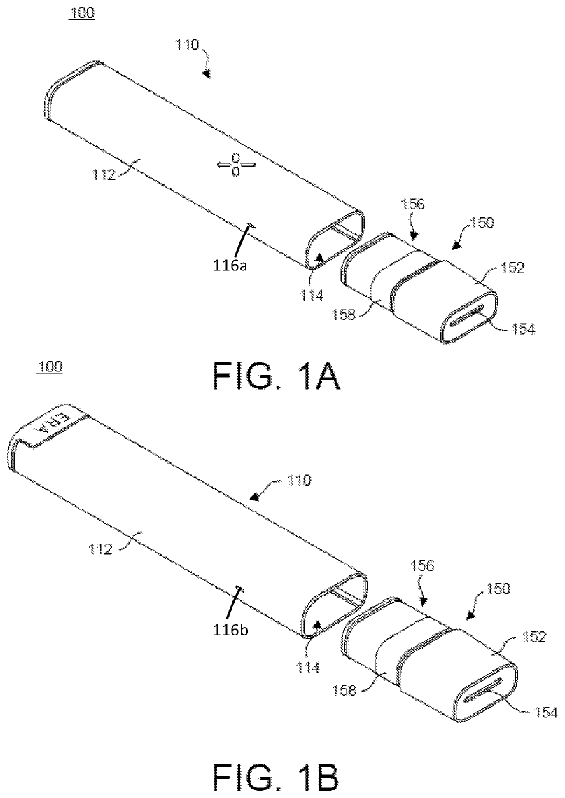

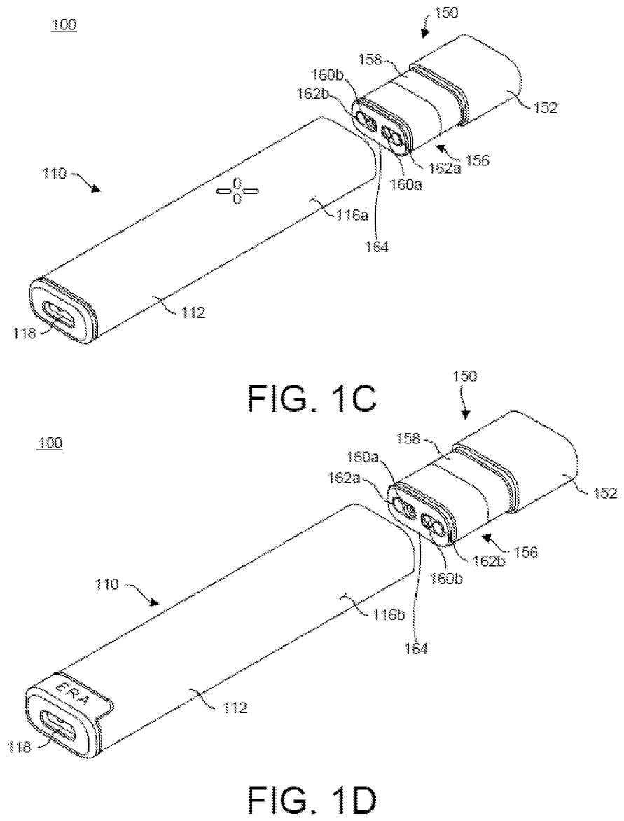

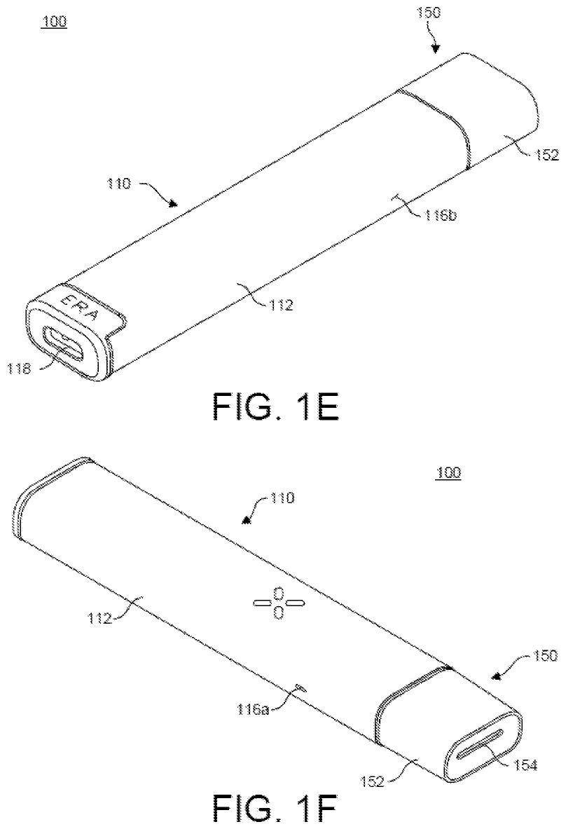

FIG. 1A-FIG. 1F illustrates features of a vaporizer device 100 including a vaporizer body 110 and a cartridge 150 consistent with implementations of the current subject matter. FIG. 1A is a bottom perspective view, and FIG. 1B is a top perspective view of the vaporizer device 100 with the cartridge 150 separated from a cartridge receptacle 114 on the vaporizer body 110. Both of the views in FIG. 1A and FIG. 1B are shown looking towards a mouthpiece 152 of the cartridge 150. FIG. 1C is a bottom perspective view, and FIG. 1D is a top perspective view of the vaporizer device with the cartridge 150 separated from the cartridge receptacle 114 of the vaporizer body 110. FIG. 1C and FIG. 1D are shown looking toward the distal end of the vaporizer body 110. FIG. 1E is top perspective view, and FIG. 1F is a bottom perspective view of the vaporizer device 100 with the cartridge 150 engaged for use with the vaporizer body 110.

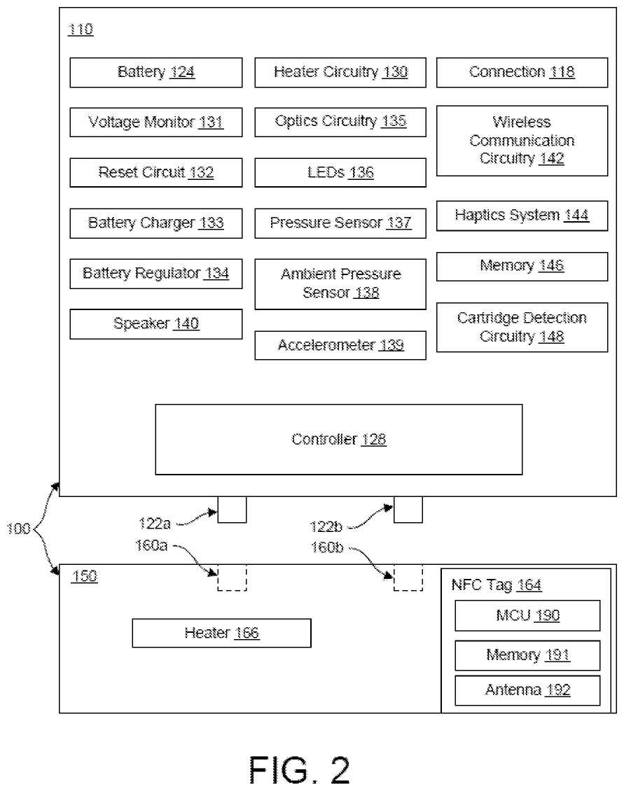

As shown in FIG. 1A-FIG. 1D, the cartridge 150 includes, at the proximal end, a mouthpiece 152 that is attached over a cartridge body 156 that forms a reservoir or tank 158 that holds a vaporizable material. The cartridge body 156 may be transparent, translucent, opaque, or a combination thereof. The mouthpiece 152 may include one or more openings 154 (see FIG. 1A, FIG. 1B, FIG. 1F) at the proximal end out of which vapor may be inhaled, by drawing breath through the vaporizer device 100. The distal end of the cartridge body 156 may couple to and be secured to the vaporizer body 110 within the cartridge receptacle 114 of the vaporizer body 110. Power pin receptacles 160a,b (see FIG. 1C, FIG. 1D) of the cartridge 150 mate with respective power pins or contacts 122a,b (see, for example, FIG. 2) of the vaporizer body 110 that extend into the cartridge receptacle 114. The cartridge 150 also includes air flow inlets 162a,b on the distal end of the cartridge body 156.

A tag 164, such as a data tag, a near-field communication (NFC) tag, or other type of wireless transceiver or communication tag, may be positioned on at least a portion of the distal end of the cartridge body 156. As shown in FIG. 1C and FIG. 1D, the tag 164 may substantially surround the power pin receptacles 160a,b and the air flow inlets 162a,b, although other configurations of the tag 164 may be implemented as well. For example, the tag 164 may be positioned between the power pin receptacle 160a and the power pin receptacle 160b, or the tag 164 may be shaped as a circle, partial circle, oval, partial oval, or any polygonal shape encircling or partially encircling the power pin receptacles 160a,b and the air flow inlets 162a,b or a portion thereof.

In the example of FIG. 1A, the vaporizer body 110 has an outer shell or cover 112 that may be made of various types of materials, including for example aluminum (e.g., AL6063), stainless steel, glass, ceramic, titanium, plastic (e.g., Acrylonitrile Butadiene Styrene (ABS), Nylon, Polycarbonate (PC), Polyethersulfone (PESU), and the like), fiberglass, carbon fiber, and any hard, durable material. The proximal end of the vaporizer body 110 includes an opening forming the cartridge receptacle 114, and the distal end of the vaporizer body 110 includes a connection 118, such as, for example, a universal serial bus Type C (USB-C) connection and/or the like. The cartridge receptacle 114 portion of the vaporizer body 110 includes one or more openings (air inlets) 116a,b that extend through the outer shell 112 to allow airflow therein, as described in more detail below. The vaporizer body 110 as shown has an elongated, flattened tubular shape that is curvature-continuous, although the vaporizer body 110 is not limited to such a shape. The vaporizer body 110 may take the form of other shapes, such as, for example, a rectangular box, a cylinder, and the like.

The cartridge 150 may fit within the cartridge receptacle 114 by a friction fit, snap fit, and/or other types of secure connection. The cartridge 150 may have a rim, ridge, protrusion, and/or the like for engaging a complimentary portion of the vaporizer body 110. While fitted within the cartridge receptacle 114, the cartridge 150 may be held securely within but still allow for being easily withdrawn to remove the cartridge 150.

Although FIG. 1A-FIG. 1F illustrate a certain configuration of the vaporizer device 100, the vaporizer device 100 may take other configurations as well.

FIG. 2 is a schematic block diagram illustrating components of the vaporizer device 100 having the cartridge 150 and the vaporizer body 110 consistent with implementations of the current subject matter. Included in the vaporizer body 110 is a controller 128 that includes at least one processor and/or at least one memory configured to control and manage various operations among the components of the vaporizer device 100 described herein. For example, the controller 128 may include at least one processor, and/or at least one memory storing instructions which, when executed by the at least one processor, cause operations as described herein.

Heater control circuitry 130 of the vaporizer body 110 controls a heater 166 of the cartridge 150. The heater 166 may generate heat to provide vaporization of the vaporizable material. For example, the heater 166 may include a heating coil (e.g., a resistive heater) in thermal contact with a wick which absorbs the vaporizable material, as described in further detail below.

A battery 124 is included in the vaporizer body 110, and the controller 128 may control and/or communicate with a voltage monitor 131 which includes circuitry configured to monitor the battery voltage, a reset circuit 132 configured to reset (e.g., shut down the vaporizer device 100 and/or restart the vaporizer device 100 in a certain state), a battery charger 133, and a battery regulator 134 (which may regulate the battery output, regulate charging/discharging of the battery, and provide alerts to indicate when the battery charge is low, etc.).

The power pins 122a,b of the vaporizer body 110 engage the complementary power pin receptacles 160a,b of the cartridge 150 when the cartridge 150 is engaged with the vaporizer body 110. Alternatively, power pins may be part of the cartridge 150 for engaging complementary power pin receptacles of the vaporizer body 110. The engagement allows for the transfer of energy from an internal power source (e.g., the battery 124) to the heater 166 in the cartridge 150. The controller 128 may regulate the power flow (e.g., an amount or current and/or a voltage amount) to control a temperature at which the heater 166 heats the vaporizable material contained in the reservoir 158. According to implementations of the current subject matter, a variety of electrical connectors other than a pogo-pin and complementary pin receptacle configuration may be used to electrically connect the vaporizer body 110 and the cartridge 150, such as for example, a plug and socket connector.

The controller 128 may control and/or communicate with optics circuitry 135 (which controls and/or communicates with one or more displays such as LEDs 136 which may provide user interface output indications), a pressure sensor 137, an ambient pressure sensor 138, an accelerometer 139, and/or a speaker 140 configured to generate sound or other feedback to a user.

In some implementations, the pressure sensor 137 may be configured to sense a user drawing (i.e., inhaling) on the mouthpiece 152 and activate the heater control circuitry 130 of the vaporizer body 110 to accordingly control the heater 166 of the cartridge 150. In this way, the amount of current supplied to the heater 166 may be varied according the user's draw (e.g., additional current may be supplied during a draw, but reduced when there is not a draw taking place). The ambient pressure sensor 138 may be included for atmospheric reference to reduce sensitivity to ambient pressure changes and may be utilized to reduce false positives potentially detected by the pressure sensor 137 when measuring draws from the mouthpiece 152.

The accelerometer 139 (and/or other motion sensors, capacitive sensors, flow sensors, strain gauge(s), or the like) may be used to detect user handling and interaction, for example, to detect movement of the vaporizer body 110 (such as, for example, tapping, rolling, and/or any other deliberate movement associated with the vaporizer body 110).

The vaporizer body 110, as shown in FIG. 2, includes wireless communication circuitry 142 that is connected to and/or controlled by the controller 128. The wireless communication circuitry 142 may include a near-field communication (NFC) antenna that is configured to read from and/or write to the tag 164 of the cartridge 150. Alternatively or additionally, the wireless communication circuitry 142 may be configured to automatically detect the cartridge 150 as it is being inserted into the vaporizer body 110. In some implementations, data exchanges between the vaporizer body 110 and the cartridge 150 take place over NFC. In some implementations, data exchanges between the vaporizer body 110 and the cartridge 150 may take place via a wired connection such as various wired data protocols.

The wireless communication circuitry 142 may include additional components including circuitry for other communication technology modes, such as Bluetooth circuitry, Bluetooth Low Energy circuitry, Wi-Fi circuitry, cellular (e.g., LTE, 4G, and/or 5G) circuitry, and associated circuitry (e.g., control circuitry), for communication with other devices. For example, the vaporizer body 110 may be configured to wirelessly communicate with a remote processor (e.g., a smartphone, a tablet, a computer, wearable electronics, a cloud server, and/or processor based devices) through the wireless communication circuitry 142, and the vaporizer body 110 may through this communication receive information including control information (e.g., for setting temperature, resetting a dose counter, etc.) from and/or transmit output information (e.g., dose information, operational information, error information, temperature setting information, charge/battery information, etc.) to one or more of the remote processors.

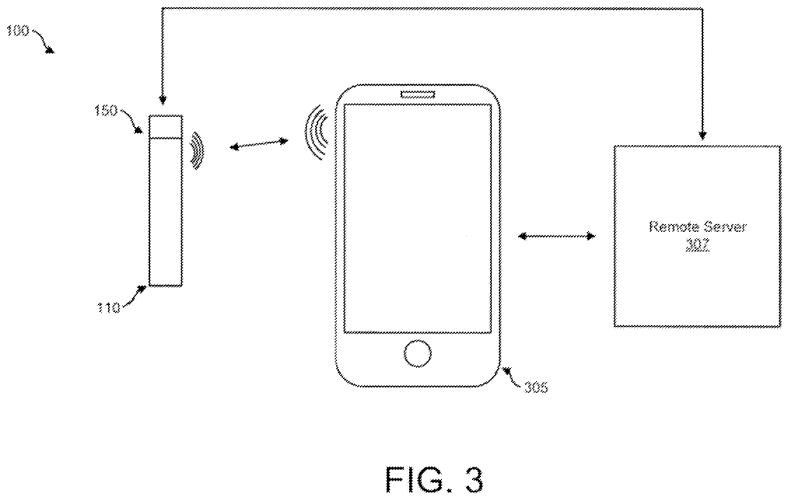

The tag 164 may be a type of wireless transceiver and may include a microcontroller unit (MCU) 190, a memory 191, and an antenna 192 (e.g., an NFC antenna) to perform the various functionalities described below with further reference to FIG. 3. The tag 164 may be, for example, a 1 Kbit or a 2 Kbit tag that is of type ISO/IEC 15693. NFC tags with other specifications may also be used. The tag 164 may be implemented as active NFC, enabling reading and/or writing information via NFC with other NFC compatible devices including a remote processor, another vaporizer device, and/or wireless communication circuitry 142. Alternatively, the tag 164 may be implemented using passive NFC technology, in which case other NFC compatible devices (e.g., a remote processor, another vaporizer device, and/or wireless communication circuitry 142) may only be able to read information from the tag 164.

The vaporizer body 110 may include a haptics system 144, such as an actuator, a linear resonant actuator (LRA), an eccentric rotating mass (ERM) motor, or the like that provide haptic feedback such as a vibration as a “find my device” feature or as a control or other type of user feedback signal. For example, using an app running on a user device (such as, for example, a user device 305 shown in FIG. 3), a user may indicate that he/she cannot locate his/her vaporizer device 100. Through communication via the wireless communication circuitry 142, the controller 128 sends a signal to the haptics system 144, instructing the haptics system 144 to provide haptic feedback (e.g., a vibration). The controller 128 may additionally or alternatively provide a signal to the speaker 140 to emit a sound or series of sounds. The haptics system 144 and/or speaker 140 may also provide control and usage feedback to the user of the vaporizer device 100; for example, providing haptic and/or audio feedback when a particular amount of a vaporizable material has been used or when a period of time since last use has elapsed. Alternatively or additionally, haptic and/or audio feedback may be provided as a user cycles through various settings of the vaporizer device 100. Alternatively or additionally, the haptics system 144 and/or speaker 140 may signal when a certain amount of battery power is left (e.g., a low battery warning and recharge needed warning) and/or when a certain amount of vaporizable material remains (e.g., a low vaporizable material warning and/or time to replace the cartridge 150). Alternatively or additionally, the haptics system 144 and/or speaker 140 may also provide usage feedback and/or control of the configuration of the vaporizer device 100 (e.g., allowing the change of a configuration, such as target heating rate, heating rate, etc.).

The vaporizer body 110 may include circuitry for sensing/detecting when a cartridge 150 is connected and/or removed from the vaporizer body 110. For example, cartridge-detection circuitry 148 may determine when the cartridge 150 is connected to the vaporizer body 110 based on an electrical state of the power pins 122a,b within the cartridge receptacle 114. For example, when the cartridge 150 is present, there may be a certain voltage, current, and/or resistance associated with the power pins 122a,b, when compared to when the cartridge 150 is not present. Alternatively or additionally, the tag 164 may also be used to detect when the cartridge 150 is connected to the vaporizer body 110.

The vaporizer body 110 also includes the connection (e.g., USB-C connection, micro-USB connection, and/or other types of connectors) 118 for coupling the vaporizer body 110 to a charger to enable charging the internal battery 124. Alternatively or additionally, electrical inductive charging (also referred to as wireless charging) may be used, in which case the vaporizer body 110 would include inductive charging circuitry to enable charging. The connection 118 at FIG. 2 may also be used for a data connection between a computing device and the controller 128, which may facilitate development activities such as, for example, programming and debugging, for example.

The vaporizer body 110 may also include a memory 146 that is part of the controller 128 or is in communication with the controller 128. The memory 146 may include volatile and/or non-volatile memory or provide data storage. In some implementations, the memory 146 may include 8 Mbit of flash memory, although the memory is not limited to this and other types of memory may be implemented as well.

FIG. 3 illustrates communication between the vaporizer device 100 (including the vaporizer body 110 and the cartridge 150), the user device 305 (e.g., a smartphone, tablet, laptop, desktop computer, a workstation, and/or the like), and a remote server 307 (e.g., a server coupled to a network, a cloud server coupled to the Internet, and/or the like) consistent with implementations of the current subject matter. The user device 305 wirelessly communicates with the vaporizer device 100. A remote server 307 may communicate directly with the vaporizer device 100 or through the user device 305. The vaporizer body 110 may communicate with the user device 305 and/or the remote server 307 through the wireless communication circuitry 142. In some implementations, the cartridge 150 may establish through the tag 164 communication with the vaporizer body 110, the user device 305, and/or the remote server 307. While the user device 305 in FIG. 3 is depicted as a type of handheld mobile device, the user device 305 consistent with implementations of the current subject matter is not so limited and may be, as indicated, various other types of user computing devices.

An application software (“app”) running on at least one of the remote processors (the user device 305 and/or the remote server 307) may be configured to control operational aspects of the vaporizer device 100 and receive information relating to operation of the vaporizer device 100. For example, the app may provide a user with capabilities to input or set desired properties or effects, such as, for example, a particular temperature or desired dose, which is then communicated to the controller 128 of the vaporizer body 110 through the wireless communication circuitry 142. The app may also provide a user with functionality to select one or more sets of suggested properties or effects that may be based on the particular type of vaporizable material in the cartridge 150. For example, the app may allow adjusting heating based on the type of vaporizable material, the user's (of the vaporizer device 100) preferences or desired experience, and/or the like. The app may be a mobile app and/or a browser-based or web app. For example, the functionality of the app may be accessible through one or more web browsers running on one or more types of user computing devices.

Data read from the tag 164 from the wireless communication circuitry 142 of the vaporizer body 110 may be transferred to one or more of the remote processors (e.g., the user device 305 and/or the remote server 307) to which it is connected, which allows for the app running on the one or more processors to access and utilize the read data for a variety of purposes. For example, the read data relating to the cartridge 150 may be used for providing recommended temperatures, dose control, usage tracking, and/or assembly information.

The cartridge 150 may also communicate directly, through the tag 164, with other devices. This enables data relating to the cartridge 150 to be written to/read from the tag 164, without interfacing with the vaporizer body 110. The tag 164 thus allows for identifying information (e.g., pod ID, batch ID, etc.) related to the cartridge 150 to be associated with the cartridge 150 by one or more remote processors. For example, when the cartridge 150 is filled with a certain type of vaporizable material, this information may be transmitted to the tag 164 by filling equipment. Then, the vaporizer body 110 is able to obtain this information from the tag 164 (e.g., via the wireless communication circuitry 142 at the vaporizer body 110) to identify the vaporizable material currently being used and accordingly adjust the controller 128 based on, for example, user-defined criteria or pre-set parameters associated with the particular type of vaporizable material (set by a manufacturer or as determined based upon user experiences/feedback aggregated from other users). For example, a user may establish (via the app) a set of criteria relating to desired effects for or usage of one or more types of vaporizable materials. When a certain vaporizable material is identified, based on communication via the tag 164, the controller 128 may accordingly adopt the established set of criteria, which may include, for example, temperature and dose, for that particular vaporizable material.

Consistent with implementations of the current subject matter, the vaporizable material used with the vaporizer device may be provided within the cartridge. The vaporizer device may be a cartridge-using vaporizer device, a cartridge-less vaporizer device, or a multi-use vaporizer device capable of use with or without a cartridge. For example, a multi-use vaporizer device may include a heating chamber (e.g., an oven) configured to receive the vaporizable material directly in the heating chamber and also configured to receive the cartridge having a reservoir or the like for holding the vaporizable material. In various implementations, the vaporizer device may be configured for use with liquid vaporizable material (e.g., a carrier solution in which an active and/or inactive ingredient(s) are suspended or held in solution or a liquid form of the vaporizable material itself) or solid vaporizable material. Solid vaporizable material may include a plant material that emits some part of the plant material as the vaporizable material (e.g., such that some part of the plant material remains as waste after the vaporizable material is emitted for inhalation by a user) or optionally may be a solid form of the vaporizable material itself such that all of the solid material may eventually be vaporized for inhalation. Liquid vaporizable material may likewise be capable of being completely vaporized or may include some part of the liquid material that remains after all of the material suitable for inhalation has been consumed.

As described above, the vaporizer device 100 and/or the user device 305 that is part of a vaporizer system as defined above may include a user interface (e.g., including an app or application software) that may be executed on the user device 305 in communication, which may be configured to determine, display, enforce, and/or meter dosing.

Software, firmware, or hardware that is separate or separable from the vaporizer device and that wirelessly communicates with the vaporizer device may be provided as described with respect to FIG. 3. For example, applications (“apps”) may be executed on a processor of a portable and/or wearable device, including smartphones, smartwatches, and the like, which may be referred to as a personal digital device, a user device, or optionally just a device (e.g., user device 305 in FIG. 3) that is part of a connected system. These digital devices may provide an interface for the user to engage and interact with functions related to the vaporizer device, including communication of data to and from the vaporizer device to the digital device or the like and/or additional third party processor (e.g., servers such as the remote server 307 in FIG. 3). For example, a user may control some aspects of the vaporizer device (temperature, session size, etc.) and/or data transmission and data receiving to and from the vaporizer device, optionally over a wireless communication channel between first communication hardware of the digital device and second communication hardware of the vaporizer device. Data may be communicated in response to one or more actions of the user (e.g., including interactions with a user interface displayed on the device), and/or as a background operation such that the user does not have to initiate or authorize the data communication process.

User interfaces may be deployed on the digital device and may aid the user in operating the vaporizer device. For example, the user interface operating on the digital device may include icons and text elements that may inform the user of various ways that vaporizer settings may be adjusted or configured by the user. In this manner (or in others consistent with the current subject matter) information about the vaporizer device may be presented using a user interface displayed by the digital device. Icons and/or text elements may be provided to allow the user to see information regarding one or more statuses of the vaporizer device, such as battery information (charge remaining, draws remaining, time to charge, charging, etc.), cartridge status (e.g., type of cartridge and vaporizable material, fill status of cartridge, etc.), and other device statuses or information. Icons and/or text elements may be provided to allow the user to update internal software (a.k.a., firmware) in the vaporizer device. Icons and text elements may be provided to allow the user to set security and/or authorization features of the vaporizer device, such as setting a PIN code to activate the vaporizer device or the use of personal biometric information as a way of authentication. Icons and text elements may be provided to allow the user to configure foreground data sharing and related settings.

The vaporizer device may perform onboard data gathering, data analysis, and/or data transmission methods. As mentioned, the vaporizer device having wired or wireless communication capability may interface with digital consumer technology products such as smart phones, tablet computers, laptop/netbook/desktop computers, wearable wireless technologies such as “smart watches,” and other wearable technology such as Google “Glass,” or similar through the use of programming, software, firmware, GUI, wireless communication, wired communication, and/or software commonly referred to as application(s) or “apps.” A wired communication connection may be used to interface the vaporizer device to digital consumer technology products for the purpose of the transmission and exchange of data to/from the vaporizer device from/to the digital consumer technology products (and thereby also interfacing with apps running on the digital consumer technology products). A wireless communication connection may be used to interface the vaporizer device to digital consumer technology products for the transmission and exchange of data to/from the vaporizer device from/to the digital wireless interface. The vaporizer device may use a wireless interface that includes one or more of an infrared (IR) transmitter, a Bluetooth interface, an 802.11 specified interface, and/or communications with a cellular telephone network in order to communicate with consumer technology.

Aspects of the current subject matter relating to cartridge type detection of a vaporizer cartridge are not limited to use with the particular and/or exact configurations and/or components of the vaporizer device 100, the vaporizer body 110, and the cartridge 150 described with reference to FIG. 1A-FIG. 3. Rather, the foregoing descriptions are provided as examples in which the described aspects may be utilized. Variations of the example vaporizer devices described herein may be used with aspects of the current subject matter directed to cartridge type detection of a vaporizer cartridge. For example, in some implementations, a single-use integrated vaporizer device may employ the aspects of the current subject matter. Aspects of the current subject matter may be employed with various other vaporizer devices, vaporizer bodies, and cartridges and/or with various modifications of the vaporizer device 100, the vaporizer body 110, and the cartridge 150, described herein. For example, consistent with implementations of the current subject matter, various sensors and circuitry may not be required for the operations provided herein. For example, the accelerometer 139 and/or the pressure sensor 137 may not be required in some implementations. Various other combinations of configurations and/or components of the vaporizer device 100, the vaporizer body 110, and the cartridge 150 may be employed consistent with implementations of the current subject matter.

Additionally, while some implementations of the current subject matter may be described with respect to cannabis and cannabinoid-based vaporizable materials, for example cannabis oils, the disclosure is not limited to cannabis and cannabinoid-based vaporizable materials and may be applicable to other types of materials.

Generally, vaporizer cartridges may include an NFC tag, a QR code, or other means for communicating with a corresponding vaporizer body. For example, the tag may enable data relating to the cartridge coupled to the vaporizer body to be written to/read from. The vaporizer body may thus be able to obtain identifying information (e.g., pod ID, batch ID, etc.) related to the cartridge from the tag. Based on the identifying information, the vaporizer body may authenticate the vaporizer cartridge that has been coupled to the vaporizer body. Authenticating the cartridge can be beneficial for the user. For example, authenticating the cartridge can provide the user with useful information about the source of the cartridge, the contents of the cartridge, and/or the like, and can confirm that the pod was manufactured by the proper manufacturer. Thus, authenticating the cartridge (or providing an indication of the provenance of the cartridge) can lead to an improved and safer user experience.

Vaporizer devices may also use the identifying information to adjust, based on user-defined criteria or pre-set parameters associated with the particular type of cartridge or type of vaporizable material contained within the vaporizer cartridge. When the particular type of vaporizable material or cartridge is identified, such as via the NFC tag, the vaporizer body may adopt the established set of criteria, which may include temperature and dose, for that particular vaporizable material or type of cartridge.

While, as noted above, authenticating the cartridge and obtaining identifying information from the cartridge, such as via the NFC tag, QR code, and/or the like, may be useful, in many instances, the vaporizer cartridge may not include an NFC tag, a QR code, or another means of wirelessly communicating with the vaporizer body. In other instances, the vaporizer body may not be enabled for reading the NFC tag, QR code, or the like, of the vaporizer cartridge. In such instances, the vaporizer body may be unable to authenticate the vaporizer cartridge and/or obtain the identifying information.

The vaporizer device consistent with implementations of the current subject matter may detect a cartridge type of a vaporizer cartridge, but this detection may not use an NFC tag, a QR code, other means of wirelessly communicating with the vaporizer cartridge, and/or the like. For example, the vaporizer device, such as via the controller 128, consistent with implementations of the current subject matter may detect the cartridge type of the vaporizer cartridge based on a measured heating profile of the vaporizer cartridge, a measured pressure profile of the vaporizer cartridge, and/or the like. Accordingly, the vaporizer device can authenticate the cartridge and/or obtain identifying information about the vaporizer cartridge without wireless communications between the cartridge and vaporizer body, but instead use the measured heating profile and/or measured pressure profile of the vaporizer cartridge. Thus, the vaporizer device consistent with implementations of the current subject matter may improve the user experience and safety of the user.

For example, the vaporizer device may deploy a proportional-integral-derivative (PID) control to regulate the heater to achieve a setpoint temperature. During the application of the PID control, the vaporizer device may generate an operational heating profile of the vaporizer cartridge. For example, a temperature of the heater 166 of the vaporizer cartridge may be measured at various times to generate the operational heating profile. The operational heating profile represents a temperature curve resulting from the application of the PID control to achieve a particular user defined or preset setpoint temperature. The operational heating profile includes a heating curve defined by a plurality of temperatures of the heater of the vaporizer cartridge 150. As noted above, the plurality of temperatures may be measured over a period of time during which a setpoint temperature of the heater is achieved.

Each cartridge type of a cartridge used with (e.g., inserted into, coupled with, etc.) the vaporizer device may have a different configuration. In particular, each cartridge type may include one or more features that contribute to each cartridge type having a uniquely generated heating profile at a particular setpoint temperature such that the heater 166 of the vaporizer cartridge 150 is heated using a same amount of energy at the same rate. With constant inputs (e.g., initial setpoint temperature, amount of energy supplied to the heater 166, rate of energy supplied to the heater 166, and/or the like), the responses can be qualitatively measured and recorded as part of the uniquely generated heating profiles.

For example, each cartridge type may include a different form factor, shape, size, heater, reservoir shape and/or size, mouthpiece shape and/or size, airflow path, vaporizable material, and/or the like. Because of these differences in the configurations of each cartridge type, each cartridge type has a different heating profile, thermal profile, pressure profile, airflow path profile, and/or the like. Thus, the heating profiles (or thermal profile, pressure profile, airflow path profile, and/or the like) of certain authenticated cartridge types may be known. The heating profiles of each authenticated cartridge type, such as at various initial setpoint temperatures can be saved in the memory 146 of the vaporizer body 110. As described herein, an authenticated cartridge type may include a particular cartridge configuration (e.g., cartridge type) that has been authorized for use with the vaporizer body 110. The authenticated cartridge type may correspond to a configuration of a vaporizer cartridge for which a known or predetermined heating profile exists and/or is stored in the memory 146.

The known heating profiles of the authenticated cartridge types used to detect cartridge types of cartridges that are coupled to the vaporizer body, without establishing wireless communications between the vaporizer body and the cartridge. The known heating profiles of the authenticated cartridge types may also be used to authenticate the cartridge that is coupled to the vaporizer body, without establishing wireless communications between the vaporizer body and the cartridge. For example, the vaporizer device consistent with implementations of the current subject matter may detect, based on the generated operational heating profile, the cartridge type of the vaporizer cartridge coupled to the vaporizer device. The vaporizer device may compare the generated operational heating profile to a predetermined heating profile of an authenticated cartridge type. If the vaporizer device determines that the generated heating profile matches (e.g., is within a threshold) the predetermined heating profile, the vaporizer device may detect the cartridge type and/or authenticate the cartridge. If the vaporizer device determines that the generated heating profile does not match any of the predetermined heating profiles, the vaporizer device may determine that the vaporizer cartridge is not authentic, and as a result, may transmit an alert and/or prevent use of the vaporizer cartridge. Accordingly, the vaporizer device consistent with implementations of the current subject matter improves the user experience and safety of the user.

Additionally and/or alternatively, based on the detected cartridge type of the vaporizer cartridge, the vaporizer device may retrieve and/or apply one or more heating parameters to heat the heater 166 of the vaporizer cartridge 150 to generate the aerosol and provide a desired user experience. Accordingly, the vaporizer device consistent with implementations of the current subject matter may further improve the user experience, such as when wireless communications between the cartridge and the vaporizer body cannot be established.

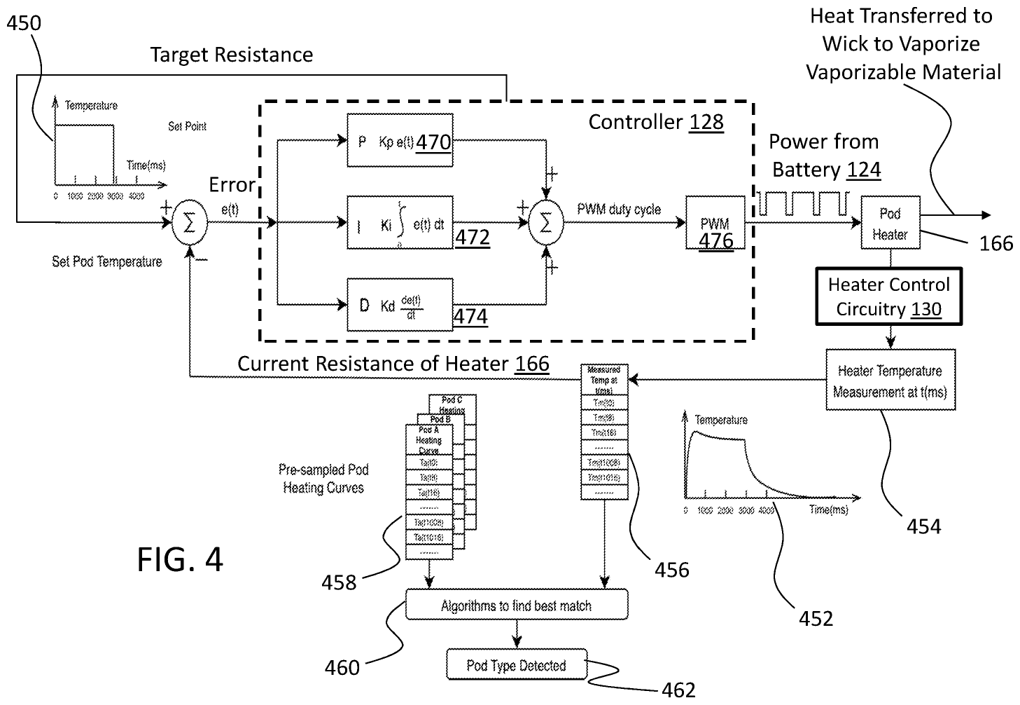

As described herein, to generate the operational heating curves used in the cartridge type detection and authentication and/or the heating curves of the authenticated cartridge types, the controller 128 may apply the PID technique. For example, referring to FIG. 2 and FIG. 4, the controller 128 may apply a proportional-integral-derivative (PID) control technique when adjusting the temperature of the heater 166 to achieve a desired setpoint temperature of the vaporizer device 100. As such, the controller 128 may continuously calculate an error corresponding to a difference between the setpoint temperature of the vaporizer device 100 and the current temperature of the vaporizer device 100, and apply a correction based on a proportional term, an integral term, and a derivative term. In some example implementations, the temperature of the heater 166 of the vaporizer device 100 may be adjusted by adjusting at least one of the proportional term, the integral term, or the derivative term of the PID control, which generates an output value that is proportional to the current error value determined by the controller 128.

For example, the controller 128 may adjust the temperature of the heater 166, including by starting or stopping the discharge of the battery 124 to the heater 166, based on an error in the current temperature of the heater 166 relative to the setpoint temperature. It should be appreciated that the temperature of the heater 166 may correspond to a resistance through the heater 166 (e.g., through a heating coil). That is, the temperature of the heater 166 may be correlated to the resistance through the heater 166 by a thermal coefficient of resistance associated with the heater 166. As such, the current resistance through the heater 166 may correspond to the current temperature of the heater 166 while the target resistance through the heater 166 may correspond to the setpoint temperature of the heater 166. Moreover, the controller 128 may start or stop the discharge of the battery 124 to the heater 166 based on an error in the current resistance through the heater 166 relative to a target resistance.

To further illustrate, FIG. 4 depicts a block diagram illustrating an example of PID control, in accordance with some implementations of the current subject matter. As shown in FIG. 4, the controller 128 may control the discharge of the battery 124 to the heater 166 of the cartridge 150 to achieve a desired setpoint temperature. For example, as shown in FIG. 4, chart 450 depicts a desired setpoint temperature, which may be achieved at a particular target resistance of the heater 166. Meanwhile, the flow of current from the battery 124 through the heater 166 may generate heat, for example, through resistive heating. The heater 166 may include a resistive heater in thermal contact with a wick of the cartridge 150 which absorbs the vaporizable material. The heat generated by the heater 166 may be transferred to the wick, which may be in thermal contact with the heater 166. For instance, the heat that is generated by the heater 166 may be transferred to the wick through conductive heat transfer, convective heat transfer, radiative heat transfer, and/or the like. The heat from the heating coil may vaporize at least some of the vaporizable material held by the wick.

Referring again to FIG. 4, the heater control circuitry 130 may be configured to determine a current resistance of the heater 166. As noted, the current resistance of the heater 166 may correspond to a current temperature of the heater 166. Accordingly, the controller 128, when applying the PID control technique, may adjust and/or maintain the temperature of the heater 166 based at least on an error e(t) between the current resistance of the heater 166 and a target resistance corresponding to the setpoint temperature for the heater 166. As shown in FIG. 4, the controller 128 may adjust, based at least on the error e(t) between the current resistance through the heater 166 and the target resistance, the discharge of the battery 124 to the heater 166. For example, the controller 128 may start the discharge of the battery 124 to the heater 166 if the current resistance of the heater 166 is below the target resistance. Alternatively or additionally, the controller 128 may stop the discharge of the battery 124 to the heater 166 if the current resistance of the heater 166 is equal to and/or above the target resistance.

The controller 128 may adjust, based at least on the error e(t) between the current resistance through the heater 166 and the target resistance, the discharge of the battery 124 to the heater 166 in order to achieve the target resistance corresponding to the setpoint temperature of the vaporizer device 100. In some implementations, the rate at which the temperature of the heater 166 is changed in order to achieve the setpoint temperature of the vaporizer device 100 may be also adjusted by at least adjusting the rate at which the battery 124 is discharged to the heating coil. Moreover, the controller 128 may adjust the discharge of the battery 124 based at least on a proportional term 470 of the PID control being applied by the controller 128. As noted, the proportional term 470 may generate an output value that is proportional to the current error value. For instance, a larger proportional term 470 may increase the step size of the change towards achieving the setpoint temperature while a smaller proportional term 470 may decrease the step size of the change towards achieving the setpoint temperature. It should be appreciated that the controller 128 may also adjust an integral term 472 and/or a derivative term 474 of the PID control to adjust the discharge of the battery 124 to heat the heater 166 rate of the vaporizer device 100.

In some example implementations, the controller 128 may be configured to adjust the setpoint temperature of the vaporizer device 100 for achieving the setpoint temperature in response to detecting a change in ambient pressure. For example, the target resistance for the heater 166 is calculated by adding a percentage change of resistance to the current resistance. When the controller 128 detects that the user is drawing from the device, the controller 128 outputs a pulse width modulation (PWM) duty cycle 476 to power the heater 166. For example, the controller 128 may detect the user is drawing from the device based on a change in the ambient pressure. The change in ambient pressure based at least on one or more measurements from the ambient pressure sensor 138. Alternatively and/or additionally, the controller 128 may detect the change in ambient pressure based on a change in the location of the vaporizer device 100. The change in the location of the vaporizer device 100 may be associated with a change in the altitude of the vaporizer device 100 as well as a corresponding change in the ambient pressure around the vaporizer device 100.

The PWM duty cycle 476 is limited to a max duty cycle that corresponds to a set maximum average power in the heater 166 calculated using battery voltage measurements and heater resistance measurements. This allows for consistent heat-up performance throughout a battery discharge cycle. The controller 128, via the PID control, uses the difference between the target heater resistance and the measured coil resistance to set the PWM duty cycle 476 to hold the measured resistance at the target resistance. The controller 128, via the PID control, holds the heater at a controlled or regulated temperature regardless of air flow rate and wicking performance of the wick to ensure a consistent experience and heating of the heater, and allows for higher or lower power at faster or slower draw rates.

In some example embodiments, the controller 128 may be configured to adjust the setpoint temperature of the vaporizer device 100 for achieving the setpoint temperature automatically, with or without notifying the user of the adjustments. Alternatively, the controller 128 may respond to detecting the change in the ambient pressure by sending, to the user, a notification that the setpoint temperature of the vaporizer device 100 requires adjustment. For example, the notification may be sent to the user device 305 and displayed by the application software running on the user device 305. Moreover, the notification may include a recommendation for the user to adjust the setpoint temperature of the vaporizer device 100. The user may respond to the notification by at least making the recommended adjustments to the setpoint temperature and/or ramp rate of the vaporizer device 100. Alternatively and/or additionally, the notification may prompt the user to consent to the adjustments to the setpoint temperature of the vaporizer device 100, as determined by the controller 128.

Referring again to FIG. 4, during the supply of power to the heater 166, the controller 128 may measure the temperature of the heater 166, at 454. The controller 128 may add the measured temperature of the heater 166 to an operational heating profile 452 of the vaporizer cartridge 150. Thus, the operational heating profile 452 may include a plurality of measured temperatures of the heater 166. The measured heater temperatures may be stored, such as in a table 456, in memory of the vaporizer cartridge 150 and/or the memory 146 of the vaporizer body 110.

Consistent with implementations of the current subject matter, the controller 128 may compare, at 460, the generated operational heating profile 452, such as the table 456, with a predetermined heating profile of an authenticated cartridge type. The predetermined heating profile may include a plurality of temperatures stored in a table 458. In other words the predetermined heating profile may be stored in one or more look-up tables that are accessible through memory 146 of the vaporizer body 110, the controller 128 via signaling with one or more remote devices, and/or the like.

Based on the comparison, the controller 128 may detect, at 462, a cartridge type of the vaporizer cartridge and/or authenticate the vaporizer cartridge. For example, the controller 128 may detect the cartridge type and/or authenticate the vaporizer cartridge when the operational heating profile matches (e.g., is within a threshold) the predetermined heating profile associated with the authenticated cartridge type. The controller 128 may communicate the cartridge type to the user, such as via an indicator on the vaporizer device 100 and/or a display of the user device 305. The controller 128 may also communicate identifying information about the vaporizer cartridge to the user, upon detecting the cartridge type. For example, the controller 128 may display, via the user device 305 or another display, batch information, vaporizable material information, and/or the like, based on the detected cartridge type of the vaporizer cartridge 150. In some implementations, when the controller 128 authenticates the vaporizer cartridge 150, the controller 128 transmits an alert, via the vaporizer device 100 and/or the user device 305 in communication with the vaporizer device 100. The alert may indicate that the vaporizer cartridge is safe to use. In some implementations, based on the authentication of the vaporizer cartridge, the controller 128 allows power to continue to be supplied to the heater 166 of the cartridge 150.

The controller 128 may additionally and/or alternatively determine, based on the comparison, that the operational heating profile does not match one of the stored predetermined heating profiles of the authenticated cartridge types. Such determination may indicate that the vaporizer cartridge is not authentic or that there is an issue (e.g., a malfunction, defective component, etc.) with the vaporizer cartridge. In such instances, it may be dangerous for the user to use or continue using the vaporizer cartridge 150. Based on the determination that the generated operational heating profile does not match the predetermined heating profile, the controller 128 may prevent power from being supplied to the heater 166. This may help to prevent use of an inauthentic vaporizer cartridge or may indicate an issue with the vaporizer cartridge, thereby improving the safety for the user. The controller 128 may additionally or alternatively send an alert to the user, such as via the vaporizer device 100 and/or the user device 305, to warn the user that the vaporizer cartridge cannot be authenticated, further improving the safety of the user.

The controller 128 may compare the generated operational heating profile to the predetermined heating profiles of the authenticated cartridge types. For example, the controller 128 may apply a statistical model, such as a regression analysis, least means squares analysis, and the like, to determine whether the operational temperature profile matches the predetermined temperature profile associated with the cartridge type. Additionally or alternatively, the controller 128 may generate a score indicating a similarity between the operational heating profile and the predetermined heating profile associated with the cartridge type. For example, the controller 128 may determine the operational temperature profile matches the predetermined temperature profile when the score meets (e.g., is greater than or equal to) a threshold score. Alternatively, the controller 128 may determine the operational temperature profile does not match the predetermined temperature profile when the score is less than the threshold score.

In some implementations, based on the detected cartridge type, the controller 128 adjusts one or more parameters of heating the vaporizable material. For example, the controller 128 may adjust the heating of the vaporizable material based on, for example, user-defined criteria or pre-set parameters associated with the particular type of vaporizable material (set by a manufacturer or as determined based upon user experiences/feedback aggregated from other users) associated with the detected cartridge type. For example, a user may establish (via the app) a set of criteria relating to desired effects for or usage of one or more types of vaporizable materials. When a certain cartridge type having a particular vaporizable material is identified, the controller 128 may accordingly adopt the established set of criteria, which may include, for example, temperature and dose, for that particular vaporizable material.

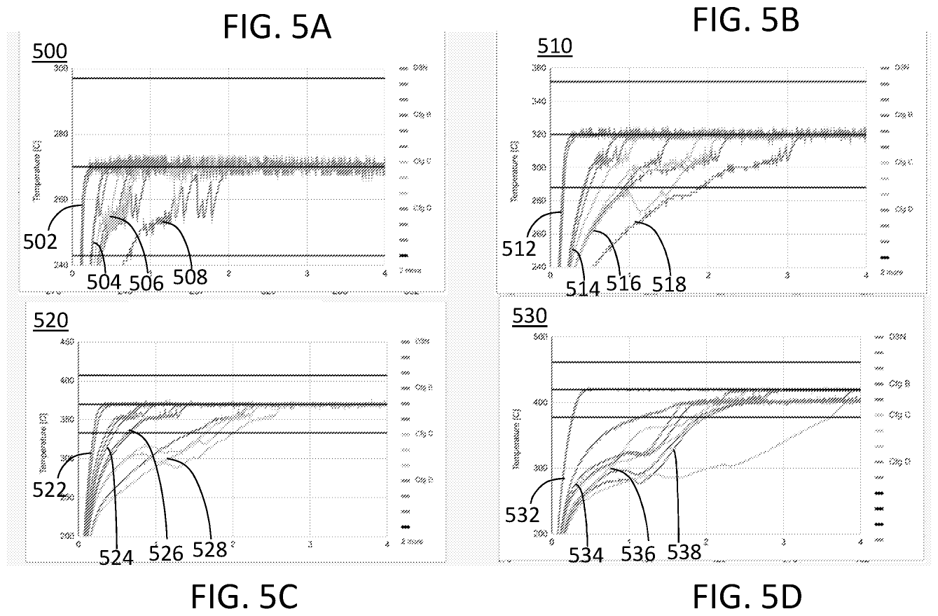

FIGS. 5A-5D illustrate examples of the operational heating profile and/or the predetermined heating profile of various cartridge types at different initial setpoint temperatures, consistent with implementations of the current subject matter. For example, FIG. 5A is a chart 500 depicting a heating profile of a first cartridge type 502, a second cartridge type 504, a third cartridge type 506, and a fourth cartridge type 508 with an initial setpoint temperature of 270° C. In other words, the chart 500 shows a comparison of the unique heating profiles of the first cartridge type 502, the second cartridge type 504, the third cartridge type 506, and the fourth cartridge type 508 when the controller 128 implements a PID control to achieve a desired setpoint temperature of 270° C.

FIG. 5B is a chart 510 depicting a heating profile of a first cartridge type 512, a second cartridge type 514, a third cartridge type 516, and a fourth cartridge type 518 with an initial setpoint temperature of 320° C. In other words, the chart 510 shows a comparison of the unique heating profiles of the first cartridge type 512, the second cartridge type 514, the third cartridge type 516, and the fourth cartridge type 518 when the controller 128 implements a PID control to achieve a desired setpoint temperature of 320° C.

FIG. 5C is a chart 520 depicting a heating profile of a first cartridge type 522, a second cartridge type 524, a third cartridge type 526, and a fourth cartridge type 528 with an initial setpoint temperature of 320° C. In other words, the chart 520 shows a comparison of the unique heating profiles of the first cartridge type 522, the second cartridge type 524, the third cartridge type 526, and the fourth cartridge type 528 when the controller 128 implements a PID control to achieve a desired setpoint temperature of 370° C.

FIG. 5D is a chart 530 depicting a heating profile of a first cartridge type 532, a second cartridge type 534, a third cartridge type 536, and a fourth cartridge type 538 with an initial setpoint temperature of 420° C. In other words, the chart 530 shows a comparison of the unique heating profiles of the first cartridge type 532, the second cartridge type 534, the third cartridge type 536, and the fourth cartridge type 538 when the controller 128 implements a PID control to achieve a desired setpoint temperature of 420° C.

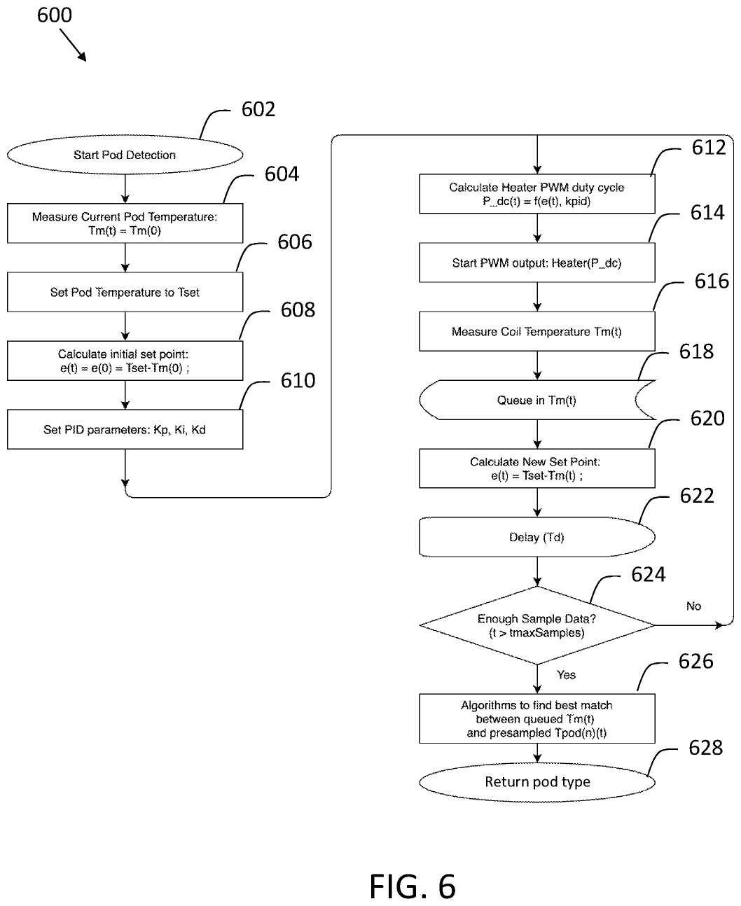

FIG. 6 illustrates an example flowchart 600 showing a method of detecting a cartridge type consistent with implementations of the current subject matter.

At 602, the controller 128 may begin a process for detecting a cartridge type of a vaporizer cartridge coupled to a vaporizer body. The controller 128 may begin the process upon activation of the vaporizer device, such as when the vaporizer device detects a user drawing on the vaporizer device, upon receipt of a user selection to detect the cartridge type, upon powering on the vaporizer device, and/or the like.

At 604, the controller 128 measures a current temperature of the vaporizer cartridge and sets the measured temperature Tm(t) as the initial temperature Tm(0).

At 606, the controller 128 may set the cartridge temperature to Tset. For example, the vaporizer device (e.g., via the vaporizer body 110 and/or a user device 305 in wireless communication with the vaporizer device) may receive a set temperature (e.g., an initial setpoint temperature). The controller 128 may set the received temperature as Tset. In some implementations, the controller 128 automatically determines an initial setpoint temperature and sets the temperature as Tset. The set temperature may indicate a desired temperature of the heater 166. For example, the controller 128 may regulate the heater to achieve the set temperature Tset.

At 608, the controller 128 calculates an initial setpoint or error value between the target heater resistance (corresponding to Tset) and a measured heater resistance. For example, the controller 128 may determine the initial error value using Equation (1):

$$e ( t ) = e ( 0 ) = T s e t - T m ( 0 ) . \qquad Equation ( 1 )$$

At 610, the controller 128 may set one or more parameters of the PID control. For example, the controller 128 may set the proportional parameter Kp, the integral parameter Ki, and/or the derivative parameter Kd of the PID control. The parameters may be adjusted to achieve the desired initial temperature setpoint.

At 612, the controller 128 may determine the PWM duty cycle to power the heater of the vaporizer cartridge 150. At 614, the controller 128 may start the PWM duty cycle. For example, the controller 128 may output the PWM duty cycle to regulate the power supplied to the heater of the vaporizer cartridge 150 to achieve the desired setpoint temperature.

At 616, the controller 128 measures a temperature (e.g., a first temperature) Tm(t) of the heater 166 of the vaporizer cartridge. The controller may generate an operational heating profile by adding the measured temperature to the heating profile. For example, the controller 128, at 618, may queue in the measured temperature Tm(t) into the heating profile.

At 620, the controller 128 calculates an updated set point. In other words, the controller 128 may determine an updated error value using Equation (2):

$$e ( t ) = T s e t - Tm ( t ) . \qquad Equation ( 2 )$$

Based on the updated error value, the controller 128 may adjust the one or more parameters of the PID control and/or the PWM duty cycle to regulate the heater of the vaporizer cartridge to achieve the initial setpoint temperature.

At 622, the controller 128 may employ a delay Td. For example, the controller 128 may wait a period of time (e.g., one ms, one to 10 ms, 10 to 100 ms, 100 to 500 ms, and/or the like) before continuing to adjust the PID control and/or measure additional temperatures to generate the operational heating profile.

At 624, the controller 128 determines whether a sufficient number of samples (e.g., temperatures) have been collected to generate the heating profile. For example, the controller 128 may determine whether an amount or total number of temperatures added to the operational heating profile meets (e.g., is greater than or equal to) a threshold amount (e.g., 10 to 100, 100 to 500, 500 to 1000, and/or the like). The controller 128 may continue to measure and add additional temperature(s) to the heating profile until the amount of temperatures meets the threshold. For example, if the controller determines the amount of temperatures has not yet met the threshold amount, the controller continues to adjust the PWM duty cycle at 612 and/or measure and add temperatures to the heating profile (e.g., repeat at least steps 612 through 624). When the controller 128 determines the amount of temperatures meets the threshold amount, the controller may store the operational heating profile and/or use the operational heating profile to detect a cartridge type.

At 626, the controller 128 may determine whether the generated operational heating profile matches at least one of the predetermined heating profiles. For example, the controller 128 may compare the operational heating profile to the predetermined heating profiles. The controller 128 may determine, based on the comparison, the cartridge type of the vaporizer cartridge 150. For example, the controller 128 may determine the cartridge type when the operational heating profile matches the predetermined heating profile associated with the cartridge type. For example, the controller 128 may apply a statistical model, such as a regression analysis, least means squares analysis, and the like, to determine whether the operational temperature profile matches the predetermined temperature profile associated with the cartridge type. Additionally or alternatively, the controller 128 may generate a score indicating a similarity between the operational heating profile and the predetermined heating profile associated with the cartridge type. For example, the controller 128 may determine the operational temperature profile matches the predetermined temperature profile when the score meets (e.g., is greater than or equal to) a threshold score. Alternatively, the controller 128 determines the operational temperature profile does not match the predetermined temperature profile when the score is less than the threshold score.

At 628, the controller may return the cartridge type of the vaporizer cartridge 150. For example, the controller 128 may cause display of an indicator (e.g., visual, audio, tactile, audiovisual, etc.) via the vaporizer device 100 and/or a user device 305 in communication with the vaporizer device 100. The controller 128 may additionally or alternatively cause display of identifying information of the vaporizer cartridge 150 such as cartridge information including the cartridge type, batch information, vaporizable material information, and the like, via a display of the user device 305 in communication with the vaporizer device 100.

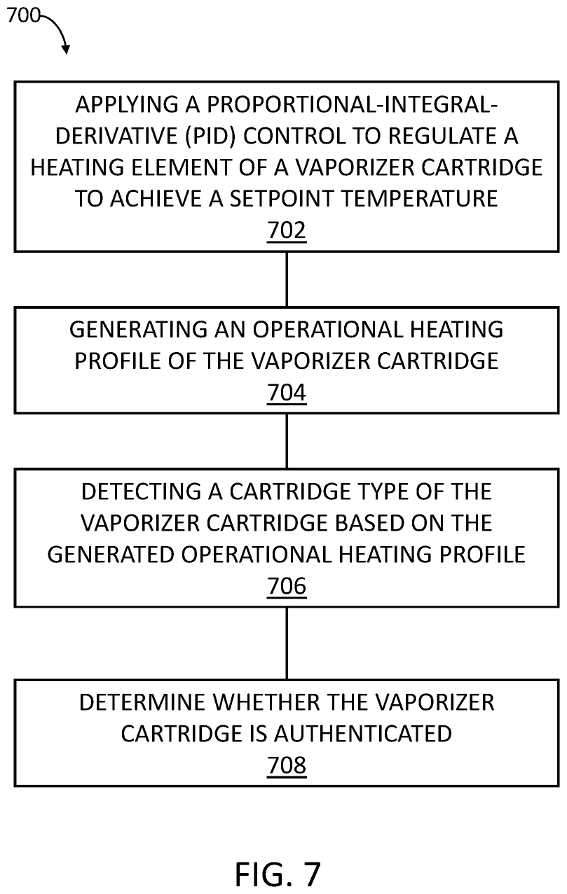

FIG. 7 illustrates an example chart 700 consistent with implementations of the current subject matter. The chart 700 illustrates features of a method, which may optionally include some or all of the following steps. With reference to FIGS. 1A-6, the features of the method may be implemented by the vaporizer device 100, such as by the cartridge 150.

At 702, a controller (e.g., the controller 128) applies a proportional-integral-derivative (PID) control to regulate a heater (e.g., the heater 166) of a vaporizer cartridge (e.g., the vaporizer cartridge 150), to achieve a setpoint temperature. The setpoint temperature may be user-defined and/or may be predetermined by the controller 128. As described herein, the phrase “proportional-integral-derivative (PID) control” refers to regulation of the heater of the vaporizer cartridge to achieve the setpoint temperature using a controller, such as a proportional-integral-derivative (PID) controller. Accordingly, in some implementations, the controller 128 is a PID controller. As described herein, the controller continuously calculates an error value e(t) as the difference between the desired setpoint temperature and a measured temperature of the heater. In some implementations, to achieve the desired setpoint temperature, the controller may apply a correction by adjusting at least one of a proportional term, an integral term, and a derivative term of the PID control.

At 704, the controller may generate an operational heating profile of the vaporizer cartridge during the application of the PID control. For example, a temperature of the heater of the vaporizer cartridge may be measured at various times to generate the operational heating profile. The operational heating profile represents a temperature curve resulting from the application of the PID control to achieve a particular user defined or preset setpoint temperature. The operational heating profile includes a heating curve defined by a plurality of temperatures of the heater of the vaporizer cartridge. The plurality of temperatures may be measured over a period of time during which a setpoint temperature of the heater is achieved.

In some implementations, generating the operational heating profile includes applying a pulse width modulation (PWM) duty cycle to supply power to and heat the heater of the vaporizer cartridge. The controller may measure a first temperature of the heater and add the measured first temperature of the heater to the operational heating profile.

In some implementations, the controller may determine a current error between the measured resistance and target resistance. In other words, the controller may measure a current temperature setpoint. Based on the current temperature setpoint or current error, the controller may adjust the PWM duty cycle applied to the heater. In doing so, the controller may adjust at least one of the proportional term, the integral term, and the derivative term of the PID control.

In some implementations, the controller may apply the adjusted PWM duty cycle to heat the heater of the vaporizer cartridge. The controller may measure a second temperature of the heater and add the measured second temperature of the heater to the operational heating profile, and so on, to build the operational heating profile. The controller builds the operational heating profile until, for example, a threshold number of temperatures have been added to the heating profile.

For example, the controller may determine whether an amount or total number of temperatures added to the operational heating profile meets (e.g., is greater than or equal to) a threshold amount (e.g., 1 to 10, 10 to 100, 100 to 500, 500 to 1000, and/or the like). The controller may continue to measure and add additional temperature(s) to the heating profile until the amount of temperatures meets the threshold. For example, if the controller determines the amount of temperatures has not yet met the threshold amount, the controller continues to adjust the PWM duty cycle and/or measure and add temperatures to the heating profile. When the controller determines the amount of temperatures meets the threshold amount, the controller may store the operational heating profile and/or use the operational heating profile to detect a cartridge type.

At 706, the controller may detect a cartridge type of the vaporizer cartridge based on the generated heating profile. The cartridge type may be one of a plurality of cartridge types. For example, the cartridge type may include one or more authenticated cartridge types. The authenticated cartridge type may include a particular cartridge configuration (e.g., cartridge type) that has been authorized for use with a particular vaporizer body to which the vaporizer cartridge is coupled. The authenticated cartridge type may correspond to a configuration of a vaporizer cartridge for which a known or predetermined heating profile exists and/or is stored in the memory of the vaporizer body.

In some implementations, a plurality of predetermined heating profiles corresponding to a respective authenticated cartridge type are stored on a memory of the vaporizer body and/or are accessible (e.g., wirelessly) to the vaporizer body. Each of the plurality of predetermined heating profiles may be associated with a particular cartridge type.

The controller may compare the operational heating profile to the predetermined heating profiles. The controller may determine, based on the comparison, the cartridge type of the vaporizer cartridge. For example, the controller may determine the cartridge type when the operational heating profile matches the predetermined heating profile associated with the cartridge type. For example, the controller may apply a statistical model, such as a regression analysis, least means squares analysis, and the like, to determine whether the operational temperature profile matches the predetermined temperature profile associated with the cartridge type. Additionally or alternatively, the controller may generate a score indicating a similarity between the operational heating profile and the predetermined heating profile associated with the cartridge type. For example, the controller may determine the operational temperature profile matches the predetermined temperature profile when the score meets (e.g., is greater than or equal to) a threshold score. Alternatively, the controller may determine the operational temperature profile does not match the predetermined temperature profile when the score is less than the threshold score.

At 708, the controller may determine whether the vaporizer cartridge is authentic. For example, the controller may authenticate the vaporizer cartridge based on the detected cartridge type. In some implementations, the controller determines whether the vaporizer cartridge is authentic based on the comparison between the operational heating profile and the predetermined heating profiles.

For example, the controller determines the vaporizer cartridge is authentic or otherwise authenticates the vaporizer cartridge when the operational heating profile matches at least one of the predetermined heating profiles. When the controller authenticates the vaporizer cartridge, the controller may permit use of the vaporizer cartridge. For example, the controller may supply current to the heater of the vaporizer cartridge to heat a vaporizable material stored in the vaporizer cartridge to generate an aerosol.

The controller may additionally or alternatively indicate to the user that the vaporizer cartridge is authenticated and/or may provide identifying information of the vaporizer cartridge to the user. For example, the controller may cause display of an indicator (e.g., visual, audio, tactile, audiovisual, etc.) via the vaporizer device and/or a user device in communication with the vaporizer device. The controller may additionally or alternatively cause display of identifying information of the vaporizer cartridge such as cartridge information including the cartridge type, batch information, vaporizable material information, and the like, via a display of the user device in communication with the vaporizer device.

In some implementations, the controller determines the vaporizer cartridge is not authentic or there is an operational issue (e.g., malfunction) with the vaporizer cartridge when the operational heating profile fails to match at least one of the predetermined heating profiles. When the controller determines the operational heating profile fails to match at least one of the predetermined heating profiles, the controller may prevent use of the vaporizer cartridge. For example, the controller may prevent a current from being supplied to the heater of the vaporizer cartridge. In some implementations, the controller indicates to the user that the vaporizer cartridge is not authenticated and/or that there is an issue with the vaporizer cartridge such that the user should not use the vaporizer cartridge. For example, the controller may cause display of an indicator (e.g., visual, audio, tactile, audiovisual, etc.) via the vaporizer device and/or a user device in communication with the vaporizer device.

Accordingly, the vaporizer device described herein may improve the user experience and safety of the user, such as when the vaporizer cartridge and the vaporizer device cannot wireless communicate with one another.

It should be appreciated that while the described methods, devices, and systems generally relate to the controller generating a heating profile and comparing the heating profile to a predetermined heating profile to detect a cartridge type, the vaporizer device may additionally and/or alternatively generate an air pressure profile and compare the air pressure profile to a predetermined air pressure profile to detect the cartridge type using the same or similar steps (e.g., the chart 700) described herein.

In some examples, the vaporizable material may include a viscous liquid such as, for example a cannabis oil. In some variations, the cannabis oil comprises between 0.3% and 100% cannabis oil extract. The viscous oil may include a carrier for improving vapor formation, such as, for example, propylene glycol, glycerol, medium chain triglycerides (MCT) including lauric acid, capric acid, caprylic acid, caproic acid, etc., at between 0.01% and 25% (e.g., between 0.1% and 22%, between 1% and 20%, between 1% and 15%, and/or the like). In some variations the vapor-forming carrier is 1,3-Propanediol. A cannabis oil may include a cannabinoid or cannabinoids (natural and/or synthetic), and/or a terpene or terpenes derived from organic materials such as for example fruits and flowers. For example, any of the vaporizable materials described herein may include one or more (e.g., a mixture of) cannabinoid including one or more of: CBG (Cannabigerol), CBC (Cannabichromene), CBL (Cannabicyclol), CBV (Cannabivarin), THCV (Tetrahydrocannabivarin), CBDV (Cannabidivarin), CBCV (Cannabichromevarin), CBGV (Cannabigerovarin), CBGM (Cannabigerol Monomethyl Ether), Tetrahydrocannabinol, Cannabidiol (CBD), Cannabinol (CBN), Tetrahydrocannabinolic Acid (THCA), Cannabidioloc Acid (CBDA), Tetrahydrocannabivarinic Acid (THCVA), one or more Endocannabinoids (e.g., anandamide, 2-Arachidonoylglycerol, 2-Arachidonyl glyceryl ether, N-Arachidonoyl dopamine, Virodhamine, Lysophosphatidylinositol), and/or a synthetic cannabinoids such as, for example, one or more of: JWH-018, JWH-073, CP-55940, Dimethylheptylpyran, HU-210, HU-331, SR144528, WIN 55,212-2, JWH-133, Levonantradol (Nantrodolum), and AM-2201. The oil vaporization material may include one or more terpene, such as, for example, Hemiterpenes, Monoterpenes (e.g., geraniol, terpineol, limonene, myrcene, linalool, pinene, Iridoids), Sesquiterpenes (e.g., humulene, farnesenes, farnesol), Diterpenes (e.g., cafestol, kahweol, cembrene and taxadiene), Sesterterpenes, (e.g., geranylfarnesol), Triterpenes (e.g., squalene), Sesquarterpenes (e.g, ferrugicadiol and tetraprenylcurcumene), Tetraterpenes (lycopene, gamma-carotene, alpha- and beta-carotenes), Polyterpenes, and Norisoprenoids. For example, an oil vaporization material as described herein may include between 0.3-100% cannabinoids (e.g., 0.5-98%, 10-95%, 20-92%, 30-90%, 40-80%, 50-75%, 60-80%, etc.), 0-40% terpenes (e.g., 1-30%, 10-30%, 10-20%, etc.), and 0-25% carrier (e.g., medium chain triglycerides (MCT)).

In any of the oil vaporizable materials described herein (including in particular, the cannabinoid-based vaporizable materials), the viscosity may be within a predetermined range. At room temperature of about 23° C., the range may be between about 30 cP (centipoise) and about 200 kcP (kilocentipoise). Alternatively, the range may be between about 30 cP and about 115 kcP. Alternatively, the range may be between about 40 cP and about 113 kcP. Alternatively, the range may be between about 50 cP and about 100 kcP. Alternatively, the range may be between about 75 cP and about 75 kcP. Alternatively, the range may be between about 100 cP and about 50 kcP. Alternatively, the range may be between about 125 cP and about 25 kcP. Outside of these ranges, the vaporizable material may fail in some instances to wick appropriately to form a vapor as described herein. In particular, it is typically desired that the oil may be made sufficiently thin to both permit wicking at a rate that is useful with the apparatuses described herein, while also limiting leaking. For example, viscosities below that of about 30 cP at room temperature might result in problems with leaking, and in some instances viscosities below that of about 100 cP at room temperature might result in problems with leaking.

Although the disclosure, including the figures, described herein may described and/or exemplify these different variations separately, it should be understood that all or some, or components of them, may be combined.

Although various illustrative embodiments are described above, any of a number of changes may be made to various embodiments. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the claims.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. References to a structure or feature that is disposed “adjacent” another feature may have portions that overlap or underlie the adjacent feature.

Terminology used herein is for the purpose of describing particular embodiments only and is not intended to be limiting. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as, for example, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings provided herein.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

As used herein in the specification and claims, including as used in the examples and unless otherwise expressly specified, all numbers may be read as if prefaced by the word “about” or “approximately,” even if the term does not expressly appear. The phrase “about” “or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, are possible.

In the descriptions above and in the claims, phrases such as, for example, “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A vaporizer device, comprising:
a vaporizer cartridge comprising a heater;
at least one processor; and
at least one memory storing instructions which, when executed by the at least one processor, cause operations comprising:
applying a proportional-integral-derivative (PID) control to regulate the heater to achieve a setpoint temperature;
generating, during the applying, an operational heating profile of the vaporizer cartridge; and
detecting, based on the generated operational heating profile, a cartridge type of the vaporizer cartridge.

2. The vaporizer device of claim 1, wherein the operations further comprise:
determining, based on the detecting, whether the vaporizer cartridge is authentic, the determining comprising: comparing the operational heating profile to a predetermined heating profile associated with the cartridge type.

3. The vaporizer device of claim 2, wherein the operations further comprise authenticating the vaporizer cartridge; and permitting, based on the authenticating, use of the vaporizer cartridge.

4. The vaporizer device of claim 2, wherein the operations further comprise: supplying current to the heater to heat a vaporizable material stored in the vaporizer cartridge to generate an aerosol.

5. The vaporizer device of claim 2, wherein the operations further comprise: determining the vaporizer cartridge is not authentic.

6. The vaporizer device of claim 5, wherein the operations further comprise:
preventing based on the determining the vaporizer cartridge is not authentic, a current from being supplied to the heater.

7. The vaporizer device of claim 5, wherein the operations further comprise: transmitting an alert indicating the vaporizer cartridge is not authentic.

8. The vaporizer device of claim 1, wherein the operational heating profile comprises a heating curve defined by a plurality of temperatures of the heater; and wherein the plurality of temperatures are measured over a period of time during which the setpoint temperature is achieved.

9. The vaporizer device of claim 1, wherein the applying the PID control comprises adjusting at least one of a proportional term, an integral term, and a derivative term of the PID control to achieve the setpoint temperature.

10. The vaporizer device of claim 1, wherein the cartridge type is one of a plurality of cartridge types.

11. The vaporizer device of claim 1, wherein the cartridge type comprises one or more of an authenticated cartridge configuration and an authenticated heater configuration.

12. The vaporizer device of claim 1, further comprising a vaporizer body coupled to the vaporizer cartridge; and wherein a plurality of cartridge types and a plurality of a predetermined heating profiles corresponding to a respective one of the plurality of cartridge types is stored on one or more of the vaporizer body and the vaporizer cartridge.

13. The vaporizer device of claim 1, wherein the detecting comprises: comparing the operational heating profile to a predetermined heating profile associated with the cartridge type.

14. The vaporizer device of claim 13, wherein the detecting further comprises: determining, based on the comparing, the cartridge type of the vaporizer cartridge when the operational heating profile matches the predetermined heating profile associated with the cartridge type.

15. The vaporizer device of claim 14, wherein the determining comprises applying a statistical model to determine the operational heating profile matches the predetermined heating profile associated with the cartridge type.

16. The vaporizer device of claim 14, wherein the determining comprises generating a score indicating a similarity between the operational heating profile and the predetermined heating profile associated with the cartridge type.

17. The vaporizer device of claim 16, wherein the determining further comprises determining the operational heating profile matches the predetermined heating profile when the score meets a threshold score.

18. The vaporizer device of claim 1, wherein the operations further comprise: causing display, via a user device communicatively coupled to the vaporizer device, of the cartridge type and cartridge information associated with the cartridge type.

19. The vaporizer device of claim 1, wherein the generating the operational heating profile comprises:
applying a pulse width modulation (PWM) duty cycle to heat the heater;
measuring a first temperature of the heater; and
adding the measured first temperature to the operational heating profile.

20. The vaporizer device of claim 19, wherein the generating the operational heating profile further comprises:
determining a current temperature setpoint; and
adjusting, based on the current temperature setpoint, the PWM duty cycle.

21. The vaporizer device of claim 20, wherein the adjusting comprises adjusting at least one of a proportional term, an integral term, and a derivative term of the PID control.

22. The vaporizer device of claim 20, wherein the generating the operational heating profile further comprises:
applying the adjusted PWM duty cycle to heat the heater;
measuring a second temperature of the heater; and
adding the measured second temperature to the operational heating profile.

23. The vaporizer device of claim 20, wherein the generating the operational heating profile further comprises: determining whether an amount of temperatures added to the operational heating profile meets a threshold amount.

24. The vaporizer device of claim 23, wherein the generating the operational heating profile further comprises: storing the operational heating profile when the amount of temperatures meets the threshold amount.

25. The vaporizer device of claim 23, wherein the generating the operational heating profile further comprises:
applying the adjusted PWM duty cycle to heat the heater;
measuring an additional temperature of the heater; and
adding the measured additional temperature to the operational heating profile.

26. The vaporizer device of claim 23, wherein the generating the operational heating profile further comprises: adding an additional measured temperature of the heater to the operational heating profile until the amount of temperatures meets a threshold temperature.

27. The vaporizer device of claim 1, further comprising a vaporizer body coupled to the vaporizer cartridge, the vaporizer body comprising the at least one processor; and the at least one memory.

28-61. (canceled)
